(19) United States
(12) Patent Application Publication
(10) Pub. No.: US 2024/0217565 A1
(43) Pub. Date: Jul. 4, 2024

(54) TRAIN DRIVING ASSISTANCE APPARATUS AND TRAIN DRIVING ASSISTANCE METHOD

(71) Applicant: Mitsubishi Electric Corporation, Chiyoda-ku, Tokyo (JP)

(72) Inventors: Ryosuke GOTO, Tokyo (JP); Masayo NAKAGAWA, Tokyo (JP)

(73) Assignee: Mitsubishi Electric Corporation, Chiyoda-ku, Tokyo (JP)

(21) Appl. No.: 18/558,371

(22) PCT Filed: Jul. 8, 2021
(86) PCT No.: PCT/JP2021/025749

§ 371 Date: Nov. 1, 2023

(51) Int. Cl. B61L 15/00

(52) U.S. Cl. CPC B61L 15/0058; B61L 15/0072

(57) ABSTRACT

A train driving assistance apparatus includes a driver information identification unit that uniquely identifies a driver; a driver behavior identification unit that identifies behavior of the driver; a train information acquisition unit that obtains train information; a travel information acquisition unit that obtains information on the train's travel; an external factor acquisition unit that obtains information on an external factor that can be a factor of a delay in operation; a driving situation discernment unit that discerns a train driving situation on the basis of information obtained from the driver information identification unit, the driver behavior identification unit, the train information acquisition unit, the travel information acquisition unit, and the external factor acquisition unit; and an assistance control unit that determines whether or not assistance is necessary for the driver and determines assistance content that aligns with the driver when the assistance is to be provided.

### FIELD

The present disclosure relates to a train driving assistance apparatus and a train driving assistance method that present a driver with information which assists with train driving operation.

### BACKGROUND

Conventionally, a driver who drives a train has referred to a run curve or the like while driving the train to grasp how the train should travel between stations. However, there are cases where the driver may not be able to drive the train as usual due to an accident, bad weather, or another impact. Furthermore, the driver may not be able to drive the train as usual due to poor physical health or another issue. For such cases, a driving assistance apparatus is under consideration to present the driver with support information necessary for operation. Patent Literature 1 discloses a driving assistance technique according to which a determination based on driver behavior, external conditions, and others is made as to whether or not driving assistance is necessary for a driver of an automobile, a train, or another vehicle, and support information is generated using a past driving assistance history.

### CITATION LIST

### Patent Literature

Patent Literature 1: Japanese Patent Application Laid-open No. 2010-205123

### SUMMARY OF INVENTION

### Problem to be Solved by the Invention

However, the above conventional technique does not consider characteristics of the driver. For example, timing when the driving assistance is required, content of the necessary driving assistance, and others conceivably differ between an experienced driver and an inexperienced driver such as a newcomer, even in cases where an impact such as an accident or bad weather causes the train driver to be unable to drive the train as usual. In other words, driving assistance that is useful to the inexperienced driver may be perceived as an annoyance by the experienced driver. Conversely, driving assistance that is useful to the experienced driver may be perceived as, for example, late timed or insufficient content by the inexperienced driver. As described, the drivers problematically perceive even the same driving assistance content differently, with some perceiving the driving assistance content to be excessive and others perceiving the driving assistance content to be insufficient.

The present disclosure has been made in view of the above, and an object of the present disclosure is to obtain a train driving assistance apparatus capable of changing driving assistance for a train driver in accordance with the driver.

### Means to Solve the Problem

In order to solve the above-described problem and achieve the object, a train driving assistance apparatus according to the present disclosure includes: a driver information identification unit to uniquely identify a driver of a train; a driver behavior identification unit to identify behavior of the driver on a basis of a physical condition of the driver; a train information acquisition unit to obtain train information indicating an operating state of the train from a train information management apparatus that controls the train and a device installed on the train; a travel information acquisition unit to obtain information on the train's travel from a train operation management apparatus; an external factor acquisition unit to obtain information on an external factor that can be a factor of a delay in operation of the train; a driving situation discernment unit to discern a train driving situation effected by the driver on a basis of information obtained from the driver information identification unit, the driver behavior identification unit, the train information acquisition unit, the travel information acquisition unit, and the external factor acquisition unit; a driving history information storage unit to store information obtained by the driving situation discernment unit and the driving situation; an assistance control unit to determine whether or not assistance is necessary for the driver on a basis of information obtained by the driving situation discernment unit and the driving situation and determine assistance content that aligns with the driver when the assistance is to be provided; and an assistance determination history storage unit to store a history of an assistance determination and the assistance content.

### Effect of the Invention

The train driving assistance apparatus according to the present disclosure has an effect of changing driving assistance for the train driver in accordance with the driver.

### BRIEF DESCRIPTION OF DRAWINGS

FIG. 1 is a diagram illustrating a configuration example of a train driving assistance apparatus according to a first embodiment.

FIG. 2 is a diagram illustrating an example of information stored in a driving history information storage unit of the train driving assistance apparatus according to the first embodiment.

FIG. 3 is a flowchart illustrating a process of determining events that trigger assistance in an assistance control unit of the train driving assistance apparatus according to the first embodiment.

FIG. 4 is a flowchart illustrating an assistance determination process in the assistance control unit of the train driving assistance apparatus according to the first embodiment.

FIG. 5 is a flowchart illustrating an assistance content determination process in the assistance control unit of the train driving assistance apparatus according to the first embodiment.

FIG. 6 is a diagram illustrating an example of information stored in an assistance determination history storage unit of the train driving assistance apparatus according to the first embodiment.

FIG. 7 is a diagram illustrating a configuration example of processing circuitry that is implemented with a processor and a memory to serve as processing circuitry of the train driving assistance apparatus according to the first embodiment.

FIG. 8 is a diagram illustrating a configuration example of processing circuitry that is configured as dedicated hardware to serve as the processing circuitry of the train driving assistance apparatus according to the first embodiment.

FIG. 9 is a flowchart illustrating a process in which an assistance control unit of a train driving assistance apparatus according to a second embodiment determines whether or not to perform the event determination process.

### DESCRIPTION OF EMBODIMENTS

With reference to the drawings, a detailed description is hereinafter provided of train driving assistance apparatuses and train driving assistance methods according to embodiments of the present disclosure.

### First Embodiment

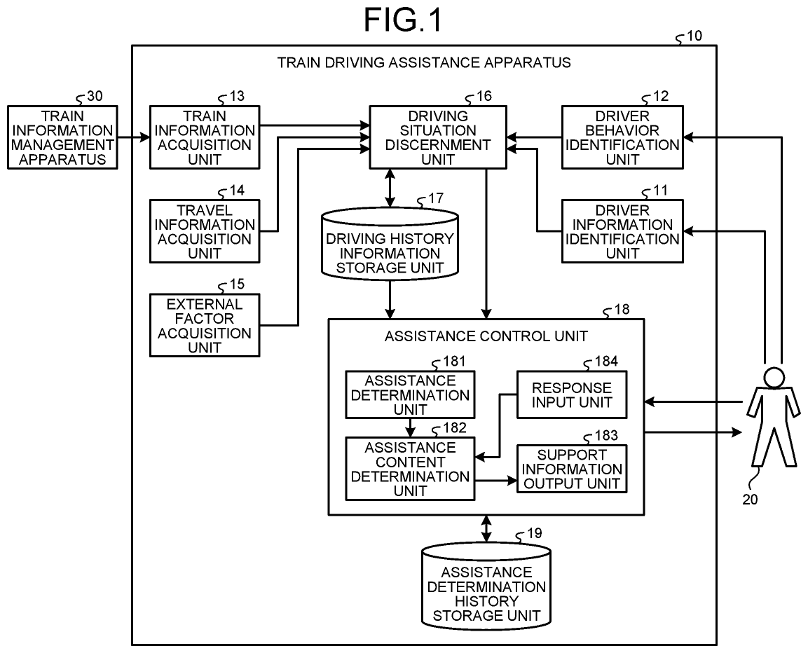

FIG. 1 is a diagram illustrating a configuration example of a train driving assistance apparatus 10 according to a first embodiment. The train driving assistance apparatus 10 is an apparatus that provides a driver 20 who drives a train not illustrated with driving assistance in accordance with a driving situation of the driver 20. The train driving assistance apparatus 10 is assumed to be installed on the train that the driver 20 drives. The train driving assistance apparatus 10 includes a driver information identification unit 11, a driver behavior identification unit 12, a train information acquisition unit 13, a travel information acquisition unit 14, an external factor acquisition unit 15, a driving situation discernment unit 16, a driving history information storage unit 17, an assistance control unit 18, and an assistance determination history storage unit 19.

The driver information identification unit 11 uniquely identifies the train driver 20. For example, the driver information identification unit 11 obtains information on the train driver 20 by a method such as receiving staff identifier (ID) specific to the driver 20 from the driver 20, reading a card with registered information on the driver 20, or face authentication, thus uniquely identifying the driver 20. The driver information identification unit 11 outputs the obtained information on the driver 20 to the driving situation discernment unit 16 as driver information.

The driver behavior identification unit 12 identifies behavior of the driver 20 on the basis of physical conditions of the driver 20. For example, the driver behavior identification unit 12 obtains the various physical conditions of the driver 20, such as information indicating whether or not a monitor screen in a driver's cab of the train is in a line of sight of the driver 20, body movement-based information indicating whether or not the driver 20 is performing pointing and calling, and a complexion and a facial expression of the driver 20 that are obtained from footage of the driver 20. On the basis of the obtained physical conditions of the driver 20, the driver behavior identification unit 12 ascertains, for example, whether or not the driver 20 is in good physical health and whether or not the driver 20 has distracted concentration, thus identifying the behavior of the driver 20. The driver behavior identification unit 12 outputs information on the identified behavior of the driver 20 to the driving situation discernment unit 16 as driver behavior information.

The train information acquisition unit 13 obtains train information indicating an operating state of the train from a train information management apparatus 30 that controls the train and devices installed on the train. The train information management apparatus 30 is an apparatus installed on the train. The train information includes, for example, information on a state of brakes installed on the train and information on a current speed of the train, among others. The train information acquisition unit 13 outputs the obtained train information to the driving situation discernment unit 16.

The travel information acquisition unit 14 obtains information on the train's travel from a train operation management apparatus not illustrated. The train operation management apparatus is installed on the ground or in another location and grasps current positions, current speeds, and others of plural trains in managing operation of each of the trains. The travel information acquisition unit 14 obtains information on the current position of the train, information indicating whether or not the operation is regular, information indicating whether or not a schedule disruption has occurred, information indicating whether or not the operation is outside the norm due to a manual route change, and other information as the travel information from the train operation management apparatus. The travel information that the travel information acquisition unit 14 obtains from the train operation management apparatus may include information on an ideal run curve for the train. The travel information acquisition unit 14 outputs the obtained travel information to the driving situation discernment unit 16.

The external factor acquisition unit 15 obtains information on any external factors that can be factors of delays in the operation of the train. The external factors that can be the factors of delays in train operation include, for example, bad weather and a train accident, among others. Therefore, the external factor acquisition unit 15 obtains weather information such as current weather and a weather forecast, information on accident occurrence conditions, and other information. The external factor acquisition unit 15 is capable of obtaining the information on the accident occurrence conditions from the above-mentioned train operation management apparatus. The external factor acquisition unit 15 may obtain the weather information directly via the Internet or the like or indirectly through the above-mentioned train operation management apparatus. The external factor acquisition unit 15 outputs the obtained information on the external factors to the driving situation discernment unit 16 as external factor information.

The driving situation discernment unit 16 discerns a train driving situation effected by the driver 20 on the basis of information obtained from the driver information identification unit 11, the driver behavior identification unit 12, the train information acquisition unit 13, the travel information acquisition unit 14, and the external factor acquisition unit 15. The driving situation discernment unit 16 obtains the driver information from the driver information identification unit 11, the driver behavior information from the driver behavior identification unit 12, the train information from the train information acquisition unit 13, the travel information from the travel information acquisition unit 14, and the external factor information from the external factor acquisition unit 15. Using the obtained information, the driving situation discernment unit 16 discerns a run curve that represents an actual train driving state effected by the driver 20 as the driving situation. The run curve that represents the actual train driving state effected by the driver 20, if included in the train information or the travel information, may be used as is by the driving situation discernment unit 16. The driving situation discernment unit 16 stores the obtained variety of information and the discerned driving situation in the driving history information storage unit 17.

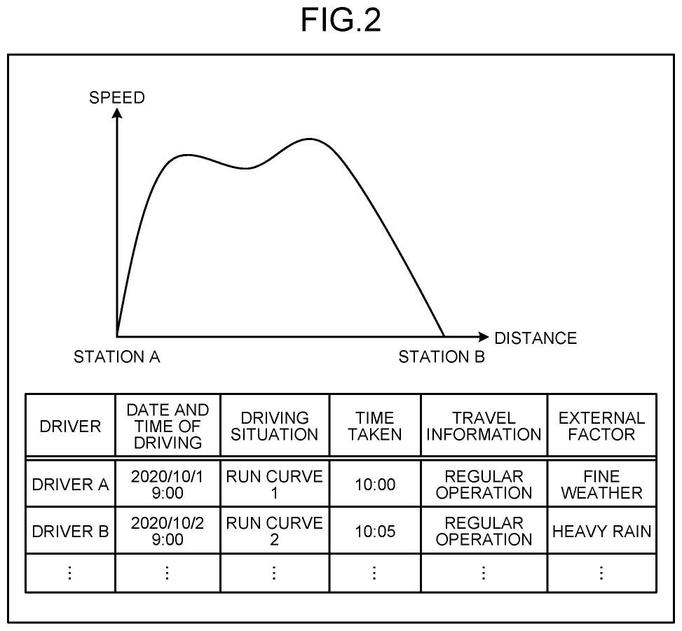

The driving history information storage unit 17 stores the information obtained by the driving situation discernment unit 16 and the driving situation. FIG. 2 is a diagram illustrating an example of information stored in the driving history information storage unit 17 of the train driving assistance apparatus 10 according to the first embodiment. For example, the driving history information storage unit 17 stores the driving situation discerned by the driving situation discernment unit 16 in the form of the run curve and stores the variety of information obtained by the driving situation discernment unit 16 as driving history information. In the example of FIG. 2, for the driving history information, the driving history information storage unit 17 stores items including “driver 20”, “date and time of driving”, “driving situation”, “time taken”, “travel information”, and “external factor” but may further store other items. A storage format illustrated in FIG. 2 is one example. The driving history information storage unit 17 may use another storage format for storage. For example, the driving history information storage unit 17 may store the driving situation discerned by the driving situation discernment unit 16 in a tabular format based on distances indicating positions of the train between stations and speeds of the train.

The assistance control unit 18 determines whether or not assistance is necessary for the driver 20 on the basis of the information obtained by the driving situation discernment unit 16 and the driving situation discerned by the driving situation discernment unit 16. When the assistance is to be provided, the assistance control unit 18 determines assistance content that aligns with the driver 20. As illustrated in FIG. 1, the assistance control unit 18 includes an assistance determination unit 181, an assistance content determination unit 182, a support information output unit 183, and a response input unit 184.

The assistance determination unit 181 determines whether or not the assistance is necessary on the basis of the information obtained by the driving situation discernment unit 16 and the driving situation. A detailed description of how the assistance determination unit 181 operates is provided later.

When the assistance determination unit 181 has determined that the assistance be provided, the assistance content determination unit 182 determines the assistance content. The assistance content determination unit 182 determines the assistance content on the basis of determination status in which the assistance determination unit 181 has made the determination to provide the assistance, thus controlling the assistance for the driver 20. A detailed description of how the assistance content determination unit 182 operates is provided later.

The support information output unit 183 presents the driver 20 with the assistance content based on the control of the assistance content determination unit 182. For example, the support information output unit 183 presents the assistance content with use of a monitor (not illustrated) or the like when text, images, and other visuals are used in assisting the driver 20 with the driving. When audio is used in assisting the driver 20 with the driving, the support information output unit 183 presents the assistance content with use of a speaker (not illustrated) or the like.

The response input unit 184 receives a response to the assistance content presented by the support information output unit 183 from the driver 20. For example, the response input unit 184 may receive, from the driver 20, the response using a switch, a touch panel, or another device, or a voice response using a microphone or the like. The response input unit 184 outputs, to the assistance content determination unit 182, the response received from the driver 20 to the assistance content.

The assistance control unit 18 stores, in the assistance determination history storage unit 19, a history of assistance determinations as well as assistance contents used when assisting the driver 20.

The assistance determination history storage unit 19 stores the history of assistance determinations made by the assistance control unit 18 and the assistance contents that the assistance control unit 18 has used when assisting the driver 20.

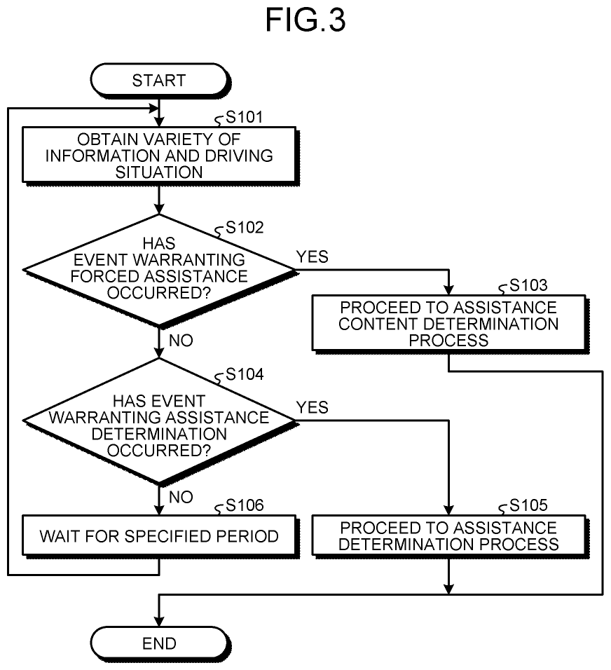

A detailed description is provided next of operations that the assistance control unit 18 performs to assist the driver 20. FIG. 3 is a flowchart illustrating a process of determining events that trigger assistance in the assistance control unit 18 of the train driving assistance apparatus 10 according to the first embodiment.

The assistance determination unit 181 of the assistance control unit 18, obtains the variety of information obtained by the driving situation discernment unit 16 and the driving situation discerned by the driving situation discernment unit 16 (step S101). The assistance determination unit 181 may obtain the variety of information and the driving situation from the driving situation discernment unit 16 or the driving history information storage unit 17. The assistance determination unit 181 determines whether or not any event warranting forced assistance has occurred (step S102).

There are plural conceivable events that each warrant forced assistance. For example, the assistance determination unit 181 determines that the event warranting the forced assistance has occurred when for at least one of items including a deviation between the ideal run curve and a current train run curve, a deviation between a speed limit and a current train speed, a deviation between scheduled passing time and actual passing time at a certain point, and a deviation between scheduled remaining time and actual remaining time in relation to remaining distance to a next station and scheduled arrival time at the next station, a case where the deviation is greater than or equal to a second threshold greater than a first threshold applies. The first threshold is specified for each of the items. If the assistance determination unit 181 determines that the event warranting the forced assistance has occurred (step S102: Yes), the assistance determination unit 181 notifies the assistance content determination unit 182 that the assistance is to be provided. Furthermore, the assistance determination unit 181 notifies the assistance content determination unit 182 at this time that its determination timing has been during the event determination process and that the event warranting the forced assistance has occurred. The assistance control unit 18 proceeds to an assistance content determination process that the assistance content determination unit 182 performs (step S103).

For each item, the second threshold is a threshold that is used in the determination of events considered as erroneous operations of the driver 20. For each item, the first threshold is a threshold that is used in determination of events that are less serious than the events considered as the erroneous operation of the driver 20 and occur at points when the driving is usually within a problem-free range. While the assistance determination unit 181 determines that the event warranting the forced assistance has occurred when the at least one of the above-mentioned items is greater than or equal to the second threshold, determining that the event warranting the forced assistance has occurred is not limited to this method. For example, the assistance determination unit 181 may determine that the event warranting the forced assistance has occurred when for plural items among the above-mentioned items, the deviation is greater than a threshold that is greater than the first threshold and less than the second threshold.

If the assistance determination unit 181 determines that no event warranting forced assistance has occurred (step S102: No), the assistance determination unit 181 determines whether or not any event warranting assistance determination has occurred (step S104). The event warranting the assistance determination occurs when, for example, a case where the deviation is greater than or equal to the first threshold specified for each item applies for at least one of the items that include the deviation between the ideal run curve and the current train run curve, the deviation between the speed limit and the current train speed, the deviation between the scheduled passing time and the actual passing time at the certain point, and the deviation between the scheduled remaining time and the actual remaining time in relation to the remaining distance to the next station and the scheduled arrival time at the next station. If the assistance determination unit 181 determines that the event warranting the assistance determination has occurred (step S104: Yes), the assistance determination unit 181 proceeds to an assistance determination process (step S105).

If the assistance determination unit 181 determines that no event warranting assistance determination has occurred (step S104: No), the assistance determination unit 181 waits for a specified period (step S106) and then returns to the operation of step S101. The assistance determination unit 181 repeats the flowchart illustrated in FIG. 3 while the train is in operation.

In the present embodiment, the assistance determination unit 181 first determines, as described earlier, whether or not any event warranting forced assistance has occurred (step S102) and then determines whether or not any event warranting assistance determination has occurred (step S104). Since the second threshold, which is used in the determination of whether or not the event warranting the forced assistance has occurred, is greater than the first threshold, which is used in the determination of whether or not the event warranting the assistance determination has occurred, the assistance determination unit 181 can usually determine whether or not the event warranting the assistance determination has occurred first. However, the event warranting the forced assistance is more urgent when occurred. Therefore, if the assistance determination unit 181 determines at the step S102 stage that the event warranting the forced assistance has occurred (step S102: Yes), the assistance control unit 18 immediately proceeds to the assistance content determination process that is performed by the assistance content determination unit 182 (step S103).

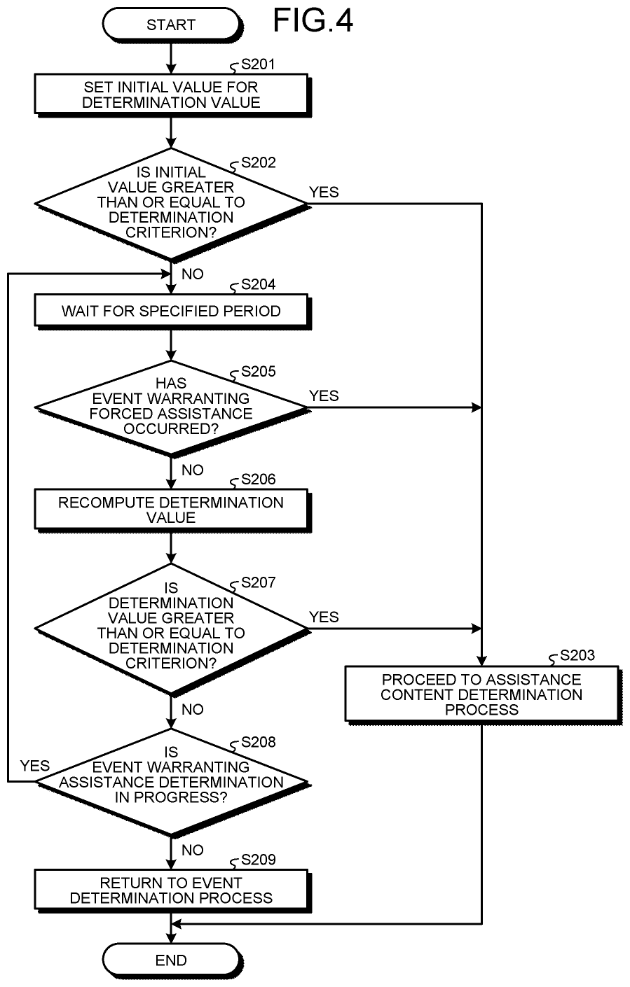

FIG. 4 is a flowchart illustrating the assistance determination process in the assistance control unit 18 of the train driving assistance apparatus 10 according to the first embodiment.

The assistance determination unit 181 of the assistance control unit 18 sets an initial value for a determination value that is used in the determination of whether or not assistance for the driver 20 is necessary (step S201). For example, on the basis of the driver information, the higher driving proficiency of the driver 20, as indicated by longer years of driving of the driver 20, more times the driver 20 has driven, and others, the smaller the initial value is set by the assistance determination unit 181. Furthermore, on the basis of the travel information, the assistance determination unit 181 sets the initial value large if the operation is not regular due to, for example, an accident occurring, compared to when the operation is regular. Furthermore, on the basis of the driving history information, the fewer times the driver 20 has driven in a corresponding section in the past and the fewer times the driver 20 has driven during a corresponding period of time, the larger the initial value is set by the assistance determination unit 181. Furthermore, the assistance determination unit 181 makes a search based on the history of assistance determinations and the assistance contents that are stored in the assistance determination history storage unit 19 to ascertain whether or not any assistances triggered by similar events have been provided in the past. If there is no history of assistance determinations for the similar events, the assistance determination unit 181 considers that the event is to be dealt with for the first time and sets the initial value larger. If there is a history of assistance determinations for the similar events, the assistance determination unit 181 considers that the event is not to be dealt with for the first time and sets the initial value small compared to when there is no history of assistance determinations for the similar events. Furthermore, the assistance determination unit 181 sets the initial value large if the weather is different from usual as the external factor, such as in cases of a heavy rain, a strong wind, and another bad weather condition, compared to when the weather is normal. For example, the more rainfall and the higher the wind speed, the larger the initial value is set. The assistance determination unit 181 may set the initial value on the basis of contents further discernible from the variety of information. As described, the more unfavorable the train driving-related conditions are for the driver 20, the larger the initial value is set by the assistance determination unit 181. The train driving-related conditions that are unfavorable for the driver 20 refer to situations in which the train is easily delayed and where recovery by the driver 20 from the delay is not easy when the train is delayed. The train driving-related conditions that are unfavorable for the driver 20 specifically refer to cases where the driver 20 has lower proficiency indicated by fewer years of driving experience of the driver 20, fewer times the driver 20 has driven, and others, cases where the operation is not regular due to, for example, the accident occurring, cases where the driver 20 has driven fewer times in the corresponding section and has driven fewer times during the corresponding period of time, cases where driver 20 has not received in the past any assistances triggered by the similar events, and the cases of the bad weather conditions such as the heavy rain and the strong wind, among others. An example of a determination criterion includes driving experience of five years or less, 100 times or less of driving, a rainfall of at least 20 mm/hour, and a strong wind with a wind speed of at least 14 m/s, among others.

If at the point when the initial value has been set for the determination value, the initial value is greater than or equal to the determination criterion that is used in providing assistance (step S202: Yes), the assistance determination unit 181 notifies the assistance content determination unit 182 that the assistance is to be provided. Furthermore, the assistance determination unit 181 notifies the assistance content determination unit 182 at this time that its determination timing has been during the assistance determination process and that the assistance determination unit 181 has not undergone an assistance timing determination loop. The assistance timing determination loop is a loop including operations of steps S204 to S208 that are described later. The assistance control unit 18 proceeds to the assistance content determination process that the assistance content determination unit 182 performs (step S203).

If at the point when the initial value has been set for the determination value, the initial value is less than the determination criterion, which is used in providing assistance (step S202: No), the assistance determination unit 181 enters the assistance timing determination loop to wait for a specified period (step S204) and then determines whether or not any event warranting forced assistance has occurred (step S205). The operation of step S205 is identical to the above-described operation of step S102 in the flowchart illustrated in FIG. 3. If the assistance determination unit 181 determines that the event warranting the forced assistance has occurred (step S205: Yes), the assistance determination unit 181 exits the assistance timing determination loop and notifies the assistance content determination unit 182 that the assistance is to be provided. Furthermore, the assistance determination unit 181 notifies the assistance content determination unit 182 at this time that its determination timing has been during the assistance determination process and that the assistance determination unit 181 has undergone the assistance timing determination loop. The assistance control unit 18 proceeds to the assistance content determination process that the assistance content determination unit 182 performs (step S203).

If the assistance determination unit 181 determines that no event warranting forced assistance has occurred (step S205: No), the assistance determination unit 181 recomputes the determination value (step S206). If the driving situation has deteriorated as progress status of the event used in the determination of the forced assistance or the assistance determination, the determination value becomes greater as a result of the determination value recomputation by the assistance determination unit 181. If the driving situation has improved, the assistance determination unit 181 does not change the determination value. For example, the assistance determination unit 181 considers that the train driving situation has deteriorated and thus increases the determination value when there is a further deviation, for example, between a current train run curve and the ideal run curve, between a current train speed and the speed limit, between passing time and scheduled passing time at a certain point, or between remaining time and scheduled remaining time until the next station. For example, the assistance determination unit 181 considers that the train driving situation has shown a tendency to improve and thus does not change the determination value when the current train run curve has approached the ideal run curve, when the current train speed has approached the speed limit, when the passing time at the certain point has approached the scheduled passing time, or when the remaining time until the next station has approached the scheduled remaining time.

The assistance determination unit 181 may determine the physical conditions of the driver 20 on the basis of the driver behavior information and increase the determination value if any of the inferred physical conditions is not good. For example, the assistance determination unit 181 infers that the driver 20 is not in good physical condition when the driver 20 is not in a stable posture, shows a prolonged eye closure during blinking, or does not focus on the driving because of the eyes of the driver 20 not looking ahead. The assistance determination unit 181 may increase the determination value if there is a sudden change in any of the external factors on the basis of the external factor information. For example, the assistance determination unit 181 increases the determination value when there is a rapid increase in the rainfall or a rapid increase in the wind speed. As described, with the determination value less than the determination criterion, the assistance determination unit 181 proceeds to recompute the determination value after the specified lapse of time if no event warranting forced assistance has occurred.

If after the determination value recomputation, the determination value is greater than or equal to the determination criterion, which is used in providing assistance (step S207: Yes), the assistance determination unit 181 exits the assistance timing determination loop and notifies the assistance content determination unit 182 that the assistance is to be provided. Furthermore, the assistance determination unit 181 notifies the assistance content determination unit 182 at this time that its determination timing has been during the assistance determination process and that the assistance determination unit 181 has undergone the assistance timing determination loop, along with providing information on the deviations and information on the initial value. The assistance control unit 18 proceeds to the assistance content determination process that the assistance content determination unit 182 performs (step S203).

If the determination value is less than the determination criterion, which is used in providing assistance (step S207: No), the assistance determination unit 181 determines whether or not the event that has warranted the assistance determination is in progress (step S208). The operation of step S208 is similar to the above-described operation of step S104 in the flowchart illustrated in FIG. 3. If the event that has warranted the assistance determination is in progress (step S208: Yes), the assistance determination unit 181 returns to the operation of step S204. If the event that has warranted the assistance determination is not in progress (step S208: No), the assistance determination unit 181 ends the assistance timing determination loop and returns to the event determination process illustrated in FIG. 3 (step S209). For example, the assistance determination unit 181 determines that the event that has warranted the assistance determination is not in progress when a case where the deviation is less than the first threshold applies for all of the above-mentioned items, such as when the current train run curve has approached the ideal run curve, when the current train speed has approached the speed limit, when the passing time at the certain point has approached the scheduled passing time, or when the remaining time until the next station has approached the scheduled remaining time.

As described, when the deviation is greater than or equal to the first specified threshold for the at least one of the items, which include the deviation between the ideal run curve and the current train run curve, the deviation between the speed limit and the current train speed, the deviation between the scheduled passing time and the actual passing time at the certain point, and the deviation between the scheduled remaining time and the actual remaining time in relation to the remaining distance to the next station and the scheduled arrival time at the next station, and when the deviation is greater than or equal to the second threshold greater than the first threshold for any of the above items, the assistance determination unit 181 considers that the event warranting the forced assistance has occurred and notifies the assistance content determination unit 182 that the assistance is to be provided. When the deviation is greater than or equal to the first threshold and less than the second threshold for any of the above items, the assistance determination unit 181 sets the initial value for the determination value, which is used in the determination of whether or not assistance is necessary, and notifies the assistance content determination unit 182 that the assistance is to be provided if the determination value is greater than or equal to the specified determination criterion.

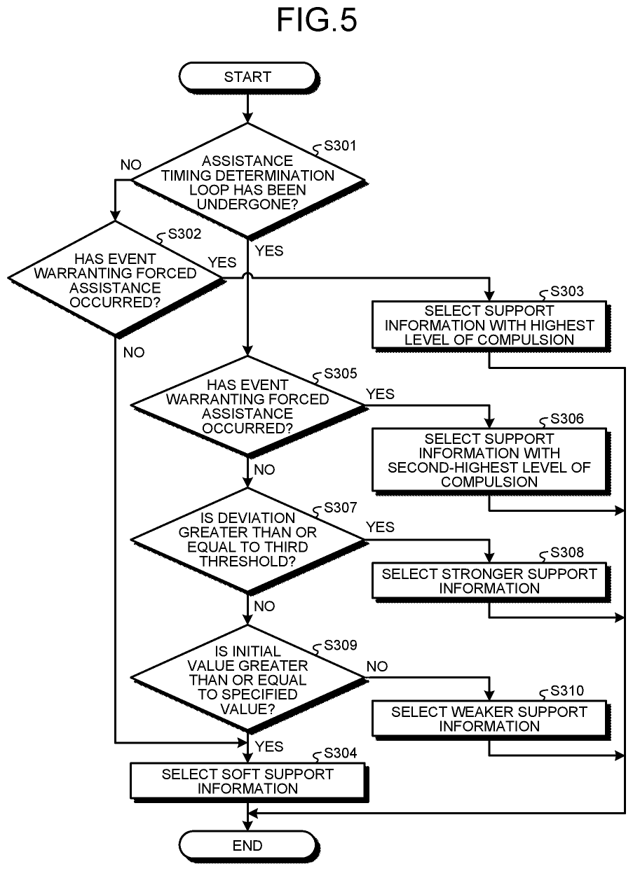

FIG. 5 is a flowchart illustrating the assistance content determination process in the assistance control unit 18 of the train driving assistance apparatus 10 according to the first embodiment. When notified by the assistance determination unit 181 that the assistance is to be provided, the assistance content determination unit 182 of the assistance control unit 18 starts the assistance content determination process illustrated in FIG. 5.

The assistance content determination unit 182 determines whether or not the assistance timing determination loop has been undergone (step S301). The assistance content determination unit 182 can determine whether or not the assistance timing determination loop has been undergone on the basis of the contents of the notification from the assistance determination unit 181. If the assistance timing determination loop has not been undergone (step S301: No), the assistance content determination unit 182 determines whether or not the event warranting the forced assistance has occurred (step S302). The assistance content determination unit 182 can determine whether or not the event warranting the forced assistance has occurred on the basis of the contents of the notification from the assistance determination unit 181. If the event warranting the forced assistance has occurred (step S302: Yes), the assistance content determination unit 182 selects support information with a highest level of compulsion as the assistance content (step S303). If no event warranting forced assistance has occurred (step S302: No), the assistance content determination unit 182 selects soft support information with a lowest level of compulsion as the assistance content (step S304). The level of compulsion indicates how urgent the support information is, with the higher level indicating greater urgency.

The case where the assistance timing determination loop has not been undergone (step S301: No) refers to the case (step S102: Yes) where the assistance determination unit 181 determines in the event determination process that the event warrants the forced assistance or the case (step S202: Yes) where the assistance determination unit 181 determines at the initial value stage of the assistance determination process that the assistance be provided. In the case of step S102: Yes, the urgency is higher, so the assistance content determination unit 182 selects the support information with the highest level of compulsion as the assistance content. In the case of step S202: Yes, the urgency is assumed to be lower, with the initial value being higher such as in the case of the driver 20 having the lower proficiency, the case where the operation is not regular, or the case of the bad weather as the external factor. Therefore, the assistance content determination unit 182 selects the soft support information as the assistance content.

If the assistance timing determination loop has been undergone (step S301: Yes), the assistance content determination unit 182 determines whether or not the event warranting the forced assistance has occurred (step S305). The operation of step S305 is identical to the above-described operation of step S302. If the event warranting the forced assistance has occurred (step S305: Yes), the assistance content determination unit 182 selects support information with a second-highest level of compulsion as the assistance content (step S306). As described, when the assistance determination unit 181 has undergone the assistance timing determination loop and determined that the event warranting the forced assistance has occurred, the assistance content determination unit 182 determines that the driving situation has deteriorated with no improvements observed and selects the support information with the second-highest level of compulsion.

If no event warranting forced assistance has occurred (step S305: No), the assistance content determination unit 182 determines, for at least one of the items that have been in the determination by the assistance determination unit 181, whether or not the deviation is greater than or equal to a third threshold that is specified to be greater than the first threshold and less than the second threshold (step S307). In other words, the assistance content determination unit 182 determines whether or not the current event is at a point of not warranting forced assistance but being close to warranting the forced support. The assistance content determination unit 182 can perform the step S307 determination by obtaining the information on the deviations from the assistance determination unit 181. If the event is close to warranting the forced assistance, meaning that the deviation is greater than or equal to the third threshold (step S307: Yes), the assistance content determination unit 182 selects stronger support information as the assistance content (step S308). As described, when the deviation is greater than or equal to the third threshold, the assistance content determination unit 182 selects the stronger support information that comes next in compulsion level after the support information with the second-highest level of compulsion.

If the event is far from warranting the forced assistance, meaning that the deviation is less than the third threshold (step S307: No), the assistance content determination unit 182 determines whether or not the initial value set by the assistance determination unit 181 is greater than or equal to a specified value (step S309). The specified value is a value smaller than the above-mentioned determination criterion. The assistance content determination unit 182 can perform the step S309 determination by obtaining the information on the initial value from the assistance determination unit 181. If the initial value is smaller, that is to say, less than the specified value (step S309: No), the assistance content determination unit 182 selects weaker support information as the assistance content (step S310). As described, when the initial value is less than the specified value, the assistance content determination unit 182 selects the weaker support information that comes next in compulsion level after the stronger support information. In this way, the larger the deviation, the more compulsory the assistance content is made by the assistance content determination unit 182. The assistance content determination unit 182 may set plural thresholds as third thresholds that are greater than the first threshold and less than the second threshold, resulting in a more detailed classification of support contents.

If the initial value is higher, that is to say, greater than or equal to the specified value (step S309: Yes), the assistance content determination unit 182 selects the soft support information with the lowest level of compulsion as the assistance content as in the case of step S302: No (step S304).

Next, a description is provided of each support information. When the assistance content determination unit 182 has selected the soft support information as the assistance content, the assistance content determination unit 182 provides interactive assistance. For example, by saying, “The distance to the next station is XX km, and the remaining time is XX minutes. Shall I notify you at the XX-km point next?”, the assistance content determination unit 182 notifies the driver 20 of the support information regarding content that triggers the event and asks the driver 20 whether additional information is needed or not. Since the assistance content determination unit 182 is not yet at this point in a situation of cautioning the driver 20, the assistance content determination unit 182 uses the wording limited to information presentation to provide the assistance that makes it easy for the driver 20 to obtain the information the driver 20 needs to make a driving decision. When there is a response such as “Yes” or “No” from the driver 20, the assistance content determination unit 182 presents next support information based on the response. The assistance content determination unit 182 gently provides the driver 20 with the information necessary for appropriate driving, thus allowing for a lightened mental burden on the driver 20. The soft support information is intended for drivers 20 who are assumed to have higher initial values set than an average driver 20. In other words, the assistance content determination unit 182 does not select, for drivers 20 with initial values less than the specified value, the soft support information that is selectable as the assistance content for the drivers 20 with the initial values greater than or equal to the specified value.

When the assistance content determination unit 182 selects the weaker support information as the assistance content, conceivable possibilities include a deterioration in the physical conditions of the driver 20 and a worsening external factor such as worsening weather. Therefore, the assistance content determination unit 182 notifies the driver 20 of information that should be attended to for the event, such as “Approaching the speed limit”. If the external factor is the case, the assistance content determination unit 182 may use interactive information such as “Shall I notify you if the wind speed increases?” or “Shall I notify you of how many curves remain?”

When the assistance content determination unit 182 selects the stronger support information as the assistance content, the event that warrants the forced assistance is assumed to be nearing. Therefore, in addition to the above-mentioned weaker support information, the assistance content determination unit 182 uses stronger wording such as “Please be careful of the speed limit” or “Please be mindful of the remaining time” to arouse attention.

It is when the event warranting the forced assistance has already been reached that the assistance content determination unit 182 selects the support information with the second-highest level of compulsion as the assistance content. Therefore, the assistance content determination unit 182 notifies the driver 20 of support information such as “The remaining time until the station is decreasing” or “Please pay attention to the speed limit” and also gives notice of explicit driving improvement content, for example, by presenting the information on the monitor in the driver's cab. The assistance content determination unit 182 may add wording that conveys urgency, such as “Please respond promptly”.

It is when the urgency is highest that the assistance content determination unit 182 selects the support information with the highest level of compulsion as the assistance content. Therefore, the assistance content determination unit 182 promptly performs a louder audio presentation of alert content with a combination of buzzer notification, flashing display of monitor information, and others. In the present embodiment, five levels of support information compulsion are assumed, with the support information with the highest level of compulsion, the support information with the second-highest level of compulsion, the stronger support information, the weaker support information, and the soft support information in order of decreasing compulsion, namely in order of decreasing urgency. However, this is not limiting. There may be four or fewer levels of support information compulsion or six or more levels of support information compulsion. These levels of support information compulsion may be expressed, for example, by numerical values starting from 1, with the urgency increasing with the increasing numerical value. As for each support information in the present embodiment, the support information with the highest level of compulsion, the support information with the second-highest level of compulsion, the stronger support information, the weaker support information, and the soft support information may also be expressed by the support information with compulsion level 5, the support information with compulsion level 4, the support information with compulsion level 3, the support information with compulsion level 2, and the support information with compulsion level 1, respectively.

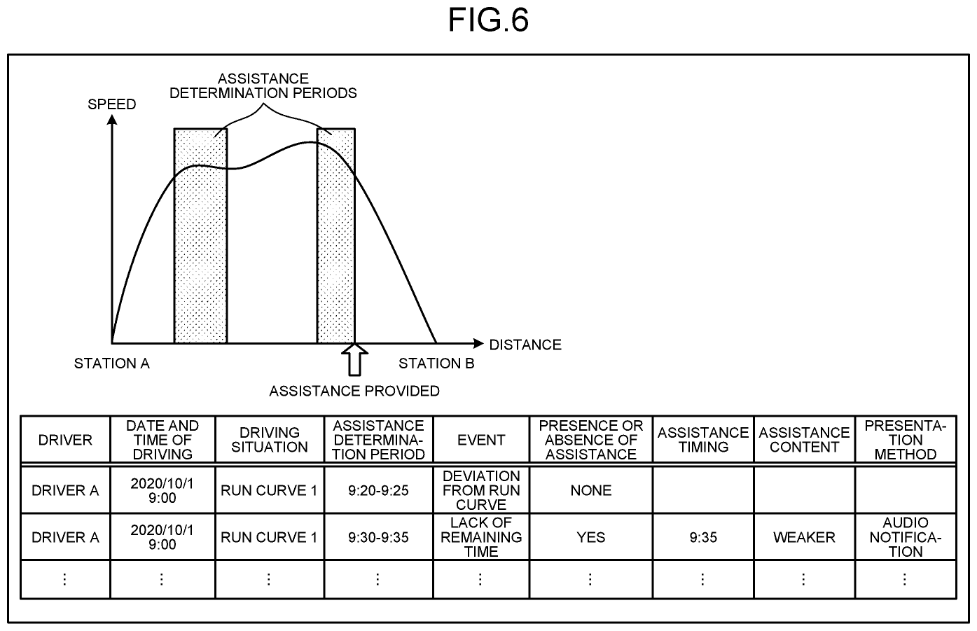

When the assistance determination unit 181 has made the assistance determination, the assistance determination unit 181 records the triggering event, progress of the determination value from the occurrence of the triggering event to the assistance, determination contents, and others as assistance determination history information. When the assistance content determination unit 182 has provided the assistance as a result of the assistance determination, the assistance content determination unit 182 records its assistance timing, an assistance level, the assistance content, and others as assistance determination history information. When the assistance content determination unit 182 has provided the interactive assistance, the assistance content determination unit 182 also records contents of a dialogue with the driver 20. FIG. 6 is a diagram illustrating an example of information stored in the assistance determination history storage unit 19 of the train driving assistance apparatus 10 according to the first embodiment. Assistance determination periods may be stored in the assistance determination history storage unit 19 to be shown on the run curve, as illustrated in FIG. 6 or in a tabular format based on the distances indicating the train positions between the stations and the train speeds. For the history of assistance determinations, the assistance determination history storage unit 19 stores items including “driver 20”, “date and time of driving”, “driving situation”, “assistance determination period”, “event”, “presence or absence of assistance”, “assistance timing”, “assistance content”, and “presentation method” but may further store other items. The assistance determination unit 181 and the assistance content determination unit 182 may perform learning using the history of assistance determinations stored in the assistance determination history storage unit 19 and others and utilize a learned result in various determinations.

Next, a description is provided of a hardware configuration of the train driving assistance apparatus 10 according to the first embodiment. The driving history information storage unit 17 and the assistance determination history storage unit 19 of the train driving assistance apparatus 10 serve as a memory. The driver information identification unit 11, the driver behavior identification unit 12, the train information acquisition unit 13, the travel information acquisition unit 14, the external factor acquisition unit 15, the driving situation discernment unit 16, and the assistance control unit 18 are implemented with processing circuitry. The processing circuitry may include a memory that stores programs and a processor that executes the programs stored in the memory or may be dedicated hardware. The processing circuitry is also referred to as control circuitry.

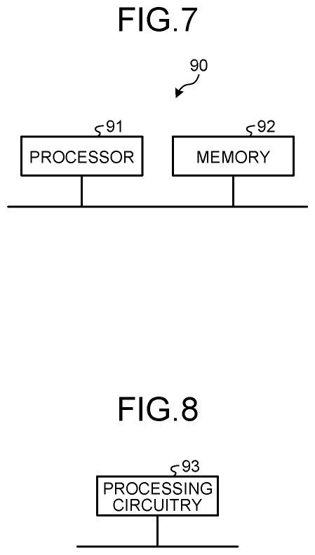

FIG. 7 is a diagram illustrating a configuration example of processing circuitry 90 that is implemented with a processor 91 and a memory 92 to serve as the processing circuitry of the train driving assistance apparatus 10 according to the first embodiment. The processing circuitry 90 illustrated in FIG. 7 is control circuitry and includes the processor 91 and the memory 92. When the processing circuitry 90 includes the processor 91 and the memory 92, the functions of the processing circuitry 90 are implemented with software, firmware, or a combination of software and firmware. The software or the firmware is described as programs and is stored in the memory 92. In the processing circuitry 90, the processor 91 reads and executes the programs stored in the memory 92 to implement the functions. This means that the memory 92 is included in the processing circuitry 90 to store the programs with which the operations of the train driving assistance apparatus 10 are eventually executed. These programs can be said to be programs that cause the functions that the processing circuitry 90 implements to be performed by the train driving assistance apparatus 10. These programs may be stored in a storage medium and provided or may be provided by another means such as a communication medium.

The above programs can also be said to cause the train driving assistance apparatus 10 to perform a driver information identification step of uniquely identifying, with the driver information identification unit 11, the train driver 20; a driver behavior identification step of identifying, with the driver behavior identification unit 12, the behavior of the driver 20 on the basis of the physical conditions of the driver 20; a train information acquisition step of obtaining, with the train information acquisition unit 13, the train information indicating the operating state of the train from the train information management apparatus 30 that controls the train and the devices installed on the train; a travel information acquisition step of obtaining, with the travel information acquisition unit 14, the information on the train's travel from the train operation management apparatus; an external factor acquisition step of obtaining, with the external factor acquisition unit 15, the information on the external factors that can be the factors of delays in the operation of the train; a driving situation discernment step of discerning, with the driving situation discernment unit 16, the train driving situation effected by the driver 20 on the basis of the information obtained from the driver information identification unit 11, the driver behavior identification unit 12, the train information acquisition unit 13, the travel information acquisition unit 14, and the external factor acquisition unit 15; and an assistance control step of determining, with the assistance control unit 18, whether or not the assistance is necessary for the driver 20 on the basis of the information obtained by the driving situation discernment unit 16 and the driving situation and determining, with the assistance control unit 18, the assistance content that aligns with the driver 20 when the assistance is to be provided.

Here examples of the processor 91 include a central processing unit (CPU), a processing unit, an arithmetic unit, a microprocessor, a microcomputer, and a digital signal processor (DSP), among others. Examples that each correspond to the memory 92 include nonvolatile or volatile semiconductor memories, such as a random-access memory (RAM), a read-only memory (ROM), a flash memory, an erasable programmable ROM (EPROM), and an electrically EPROM (EEPROM) (registered trademark), a magnetic disk, a flexible disk, an optical disk, a compact disk, a mini disk, and a digital versatile disc (DVD), among others.

FIG. 8 is a diagram illustrating a configuration example of processing circuitry 93 that is configured as dedicated hardware to serve as the processing circuitry of the train driving assistance apparatus 10 according to the first embodiment. Examples that each correspond to the processing circuitry 93 illustrated in FIG. 8 include a single circuit, a composite circuit, a programmed processor, a parallel programmed processor, an application-specific integrated circuit (ASIC), a field-programmable gate array (FPGA), and combinations of these. The processing circuitry 93 may be realized partly by dedicated hardware and partly by software or firmware. By including the dedicated hardware, the software, the firmware or a combination of these, the processing circuitry 93 is capable of implementing the above functions.

According to the present embodiment described above, the assistance control unit 18 of the train driving assistance apparatus 10 is capable of changing, in accordance with the driver 20, the timing of assistance to be started and the assistance content on the basis of the driver information, the driving situation, the history of past assistance determinations, and others. Therefore, the assistance control unit 18 can delay assistance when the driver 20 with higher proficiency tries to recover from an event such as a train delay, and if the driver 20 has succeeded in the recovery, avoid presentation of the assistance, thus preventing a situation that disturbs the concentration of the driver 20. Furthermore, the assistance control unit 18 can present support information earlier to the driver 20 with little experience of driving in an unfamiliar section. In cases where assistance is provided, the more unfavorable the train driving-related conditions are for the driver 20, the more compulsory the assistance content that the assistance control unit 18 makes, in addition to timing the assistance to start earlier. The assistance control unit 18 can prevent assistance from being excessive or insufficient by adjusting the assistance timing. The assistance control unit 18 allows for a lightened mental burden on the driver 20 by changing the assistance content, the presentation method, and others on the basis of the assistance determination status.

While the assistance control unit 18 uses the plural items, such as the deviation between the ideal run curve and the current train run curve and the deviation between the speed limit and the current train speed, in determining whether or not to assist the driver 20, the items to be used may be changed as appropriate. For example, the assistance control unit 18 may take action, such as unconditioning the deviation between the ideal run curve and the current train run curve, in cases where the train is significantly behind schedule due to an accident or another reason but is driven smoothly for recovery to the schedule.

### Second Embodiment

In the first embodiment, the train driving assistance apparatus 10 repeats the event determination process illustrated in FIG. 3 while the train is in operation. In a second embodiment, a description is provided of a train driving assistance apparatus 10 that establishes a period during which the event determination process is not performed.

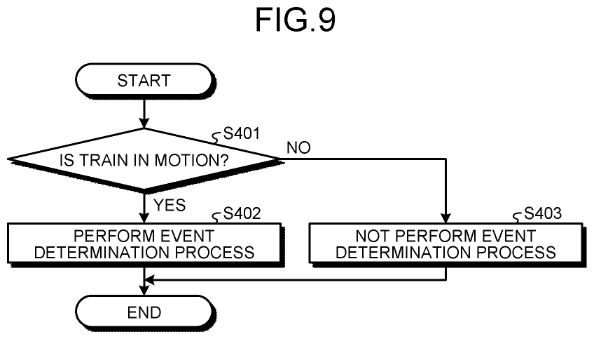

The train driving assistance apparatus 10 according to the second embodiment has the same configuration as the train driving assistance apparatus 10 according to the first embodiment that is illustrated in FIG. 1. While a driver 20 can perform control such as train speed adjustment through assistance from the train driving assistance apparatus 10, what the driver 20 can do is limited while a train is stationary at a location such as a station. Therefore, the assistance control unit 18 of the train driving assistance apparatus 10 may prevent itself from performing the event determination process illustrated in FIG. 3 when the train is stationary at the location such as the station, even in operation. FIG. 9 is a flowchart illustrating a process in which the assistance control unit 18 of the train driving assistance apparatus 10 according to the second embodiment determines whether or not to perform the event determination process. If the train is in motion (step S401: Yes), the assistance control unit 18 performs the event determination process illustrated in FIG. 3 (step S402). Subsequent operations of the train driving assistance apparatus 10 are the same as those in the first embodiment. If the train is not in motion, that is to say, stationary at the location such as the station (step S401: No), the assistance control unit 18 does not perform the event determination process illustrated in FIG. 3 (step S403).

While the assistance control unit 18 does not perform the event determination process when the train is stationary, the assistance control unit 18 may perform the event determination process even when the train is stationary if assisting the driver 20 is preferable even when the train is stationary, such as in a case where poor physical health of the driver 20 is inferred from the driver behavior information or a case where a worsening weather condition such as a localized torrential downpour is expected.

According to the present embodiment described above, the assistance control unit 18 may prevent itself from performing the event determination process in the situation where assistance for the driver 20 is unnecessary. Thus the train driving assistance apparatus 10, which is an apparatus installed on the train, can reduce processing load that the train driving assistance apparatus 10 bears.

The above configurations illustrated in the embodiments are illustrative, can be combined with other techniques that are publicly known, and can be partly omitted or changed without departing from the gist. The embodiments can be combined with each other.

### REFERENCE SIGNS LIST

10 train driving assistance apparatus; 11 driver information identification unit; 12 driver behavior identification unit; 13 train information acquisition unit; 14 travel information acquisition unit; 15 external factor acquisition unit; 16 driving situation discernment unit; 17 driving history information storage unit; 18 assistance control unit; 19 assistance determination history storage unit; 20 driver; 30 train information management apparatus; 181 assistance determination unit; 182 assistance content determination unit; 183 support information output unit; 184 response input unit.

1. A train driving assistance apparatus comprising:
a driver information identification circuitry to uniquely identify a driver of a train;
a driver behavior identification circuitry to identify behavior of the driver on a basis of a physical condition of the driver;
a train information acquisition circuitry to obtain train information indicating an operating state of the train from a train information management apparatus that controls the train and a device installed on the train;
a travel information acquisition circuitry to obtain information on the train's travel from a train operation management apparatus;
an external factor acquisition circuitry to obtain information on an external factor that can be a factor of a delay in operation of the train;
a driving situation discernment circuitry to discern a train driving situation effected by the driver on a basis of information obtained from the driver information identification circuitry, the driver behavior identification circuitry, the train information acquisition circuitry, the travel information acquisition unit circuitry, and the external factor acquisition circuitry;
a driving history information storage circuitry to store information obtained by the driving situation discernment circuitry and the driving situation; and
an assistance control circuitry to determine whether or not assistance is necessary for the driver on a basis of information obtained by the driving situation discernment circuitry and the driving situation and determine assistance content that aligns with the driver when the assistance is to be provided.

2. The train driving assistance apparatus according to claim 1, wherein
the more unfavorable a train driving-related condition is for the driver, the more compulsory the assistance content that the assistance control circuitry makes, in addition to timing the assistance to start earlier, in providing the assistance.

3. The train driving assistance apparatus according to claim 1, wherein
the assistance control circuitry includes
an assistance determination circuitry to determine whether or not the assistance is necessary on the basis of the information obtained by the driving situation discernment circuitry and the driving situation and
an assistance content determination circuitry to determine the assistance content when the assistance determination circuitry has determined that the assistance be provided.

4. The train driving assistance apparatus according to claim 3, wherein
when for at least one of items including a deviation between an ideal run curve and a current train run curve, a deviation between a speed limit and a current train speed, a deviation between scheduled passing time and actual passing time at a certain point, and a deviation between scheduled remaining time and actual remaining time in relation to remaining distance to a next station and scheduled arrival time at the next station, the deviation is greater than or equal to a first threshold that is specified, and when the deviation is greater than or equal to a second threshold greater than the first threshold for any of the items, the assistance determination circuitry notifies the assistance content determination circuitry that the assistance is to be provided, and when the deviation is greater than or equal to the first threshold and less than the second threshold for any of the items, the assistance determination circuitry sets an initial value for a determination value that is used in determination of whether or not the assistance is necessary and notifies the assistance content determination circuitry that the assistance is to be provided if the determination value is greater than or equal to a determination criterion that is specified.

5. The train driving assistance apparatus according to claim 4, wherein
the more unfavorable a train driving-related condition is for the driver, the larger the initial value is set by the assistance determination circuitry.

6. The train driving assistance apparatus according to claim 4, wherein
with the determination value less than the determination criterion, the assistance determination circuitry recomputes the determination value after a specified lapse of time.

7. The train driving assistance apparatus according to claim 4, wherein
the larger the deviation, the more compulsory the assistance content is made by the assistance content determination circuitry.

8. The train driving assistance apparatus according to claim 4, wherein
the assistance content determination circuitry does not select, for the driver with the initial value less than a specified value, the assistance content that is selectable for the driver with the initial value greater than or equal to a specified value.

9. A train driving assistance method comprising:
uniquely identifying, by a driver information identification circuitry, a driver of a train;
identifying, by a driver behavior identification circuitry, behavior of the driver on a basis of a physical condition of the driver;
obtaining, by a train information acquisition circuitry, train information indicating an operating state of the train from a train information management apparatus that controls the train and a device installed on the train;
obtaining, by a travel information acquisition circuitry, information on the train's travel from a train operation management apparatus;
obtaining, by an external factor acquisition circuitry, information on an external factor that can be a factor of a delay in operation of the train;
discerning, by a driving situation discernment circuitry, a train driving situation effected by the driver on a basis of information obtained from the driver information identification circuitry, the driver behavior identification circuitry, the train information acquisition circuitry, the travel information acquisition circuitry, and the external factor acquisition circuitry; and
determining, by an assistance control circuitry, whether or not assistance is necessary for the driver on a basis of information obtained by the driving situation discernment circuitry and the driving situation and determining, by the assistance control circuitry, assistance content that aligns with the driver when the assistance is to be provided.

10. The train driving assistance method according to claim 9, wherein
in determining the assistance content, the more unfavorable a train driving-related condition is for the driver, the more compulsory the assistance content that the assistance control circuitry makes, in addition to timing the assistance to start earlier, in providing the assistance.

11. The train driving assistance method according to claim 9, wherein
the assistance control circuitry includes an assistance determination circuitry and an assistance content determination circuitry, and
determining the assistance content includes
determining, by the assistance determination circuitry, whether or not the assistance is necessary on the basis of the information obtained by the driving situation discernment circuitry and the driving situation and
determining, by the assistance content determination circuitry, the assistance content when the assistance determination circuitry has determined that the assistance be provided.

12. The train driving assistance method according to claim 11, wherein in determining whether or not the assistance is necessary,
when for at least one of items including a deviation between an ideal run curve and a current train run curve, a deviation between a speed limit and a current train speed, a deviation between scheduled passing time and actual passing time at a certain point, and a deviation between scheduled remaining time and actual remaining time in relation to remaining distance to a next station and scheduled arrival time at the next station, the deviation is greater than or equal to a first threshold that is specified, and when the deviation is greater than or equal to a second threshold greater than the first threshold for any of the items, the assistance determination circuitry notifies the assistance content determination circuitry that the assistance is to be provided, and when the deviation is greater than or equal to the first threshold and less than the second threshold for any of the items, the assistance determination circuitry sets an initial value for a determination value that is used in determination of whether or not the assistance is necessary and notifies the assistance content determination circuitry that the assistance is to be provided if the determination value is greater than or equal to a determination criterion that is specified.

13. The train driving assistance method according to claim 12, wherein
in determining whether or not the assistance is necessary, the more unfavorable a train driving-related condition is for the driver, the larger the initial value is set by the assistance determination circuitry.

14. The train driving assistance method according to claim 12, wherein
in determining whether or not the assistance is necessary, with the determination value less than the determination criterion, the assistance determination circuitry recomputes the determination value after a specified lapse of time.

15. The train driving assistance method according to claim 12, wherein
the larger the deviation, the more compulsory the assistance content is made by the assistance content determination circuitry in determining the assistance content.

16. The train driving assistance method according to claim 12, wherein
in determining the assistance content, the assistance content determination circuitry does not select, for the driver with the initial value less than a specified value, the assistance content that is selectable for the driver with the initial value greater than or equal to a specified value.
